(19) United States
(12) Patent Application Publication
(10) Pub. No.: US 2015/0007059 A1
(43) Pub. Date: Jan. 1, 2015

(54) USER INTERFACE WITH SCROLLING FOR MULTIMODAL COMMUNICATION FRAMEWORK

(71) Applicant: Zeta Project Swiss GmbH, Zug (CH)

(72) Inventors: Priidu Zilmer, Tallinn (EE); Angel Sergio Palomo Pascual, Helsinki (FI); Oliver Reitalu, Tallinn (EE); Jaanus Kase, Tallinn (EE)

(21) Appl. No.: 14/309,883

(22) Filed: Jun. 19, 2014

Related U.S. Application Data
(60) Provisional application No. 61/841,396, filed on Jun. 30, 2013.

(51) Int. Cl. G06F 3/0484; H04L 29/06; G06F 3/0487

(52) U.S. Cl. CPC G06F 3/04842; G06F 3/0487; H04L 65/403
USPC 715/753

(57) ABSTRACT

A graphical user interface (GUI) for a device operable in a unified communication framework in which multiple users communicate using multiple modes. Conversations are kept consistent across users' devices. The GUI makes efficient use of a display during scrolling within conversations.

### RELATED APPLICATION

This application is related to and claims priority from co-owed and co-pending U.S. Patent Application No. 61/841,396, filed Jun. 30, 2013, titled “User Interface With Scrolling For Multimodal Communication Framework,” the entire contents of which are hereby fully incorporated herein by reference for all purposes.

### BACKGROUND OF THE INVENTION

### Copyright Statement

This patent document contains material subject to copyright protection. The copyright owner has no objection to the reproduction of this patent document or any related materials in the files of the United States Patent and Trademark Office, but otherwise reserves all copyrights whatsoever.

### Field of the Invention

This invention relates to a communication framework, and, more particularly, to a graphical user interface for a communication framework.

### Background and Overview

Computers and computing devices, including so-called smartphones, are ubiquitous, and much of today's communication takes place via such devices. In many parts of the world, computer-based inter-party communication has superseded POTS systems.

Various messaging systems such as, e.g., Skype, Apple's messaging system and the like, provide graphical user interfaces (GUIs) to their systems. However, the GUI's of many of these systems make very inefficient use of the screen area. The graphical user interface of a typical messaging system divides a device screen into two or three sections, a top section (optionally) for providing information about the current interaction, a middle section for displaying messages, and a bottom section for inputting messages. However, such a division of a screen is inefficient in many modes of operation.

It is desirable to provide a user interface that makes efficient use of the display area a devices' screen in multiple modes of operation and across multiple types of devices.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification.

FIG. 1 shows an overview of an exemplary communication framework in accordance with an embodiment;

FIGS. 2(A)-2(D) depict aspects of exemplary devices for use in a system in accordance with an embodiment;

FIGS. 3(A)-3(B) depict exemplary user interfaces (UIs) according to embodiments hereof;

FIG. 3(C) depicts aspects of a conversation in an exemplary communication framework such as that shown in FIG. 1;

FIGS. 4(A)-4(P) depict aspects of a user interface in accordance with embodiments hereof;

FIGS. 5(A)-5(C) depict aspects of computing and computer devices in accordance with embodiments hereof.

### DETAILED DESCRIPTION OF THE PRESENTLY PREFERRED EXEMPLARY EMBODIMENTS

### Glossary and Abbreviations

As used herein, unless used otherwise, the following terms or abbreviations have the following meanings:

API means application programming interface;

GUI means graphical user interface (UI);

UI means user interface;

URI means Uniform Resource Identifier;

URL means Uniform Resource Locator;

VKB means virtual keyboard.

As used herein, the term “mechanism” refers to any device(s), process(es), service(s), or combination thereof A mechanism may be implemented in hardware, software, firmware, using a special-purpose device, or any combination thereof A mechanism may be integrated into a single device or it may be distributed over multiple devices. The various components of a mechanism may be co-located or distributed. The mechanism may be formed from other mechanisms. In general, as used herein, the term “mechanism” may thus be considered shorthand for the term device(s) and/or process(es) and/or service(s).

### Background and Overview

Overview—Structure

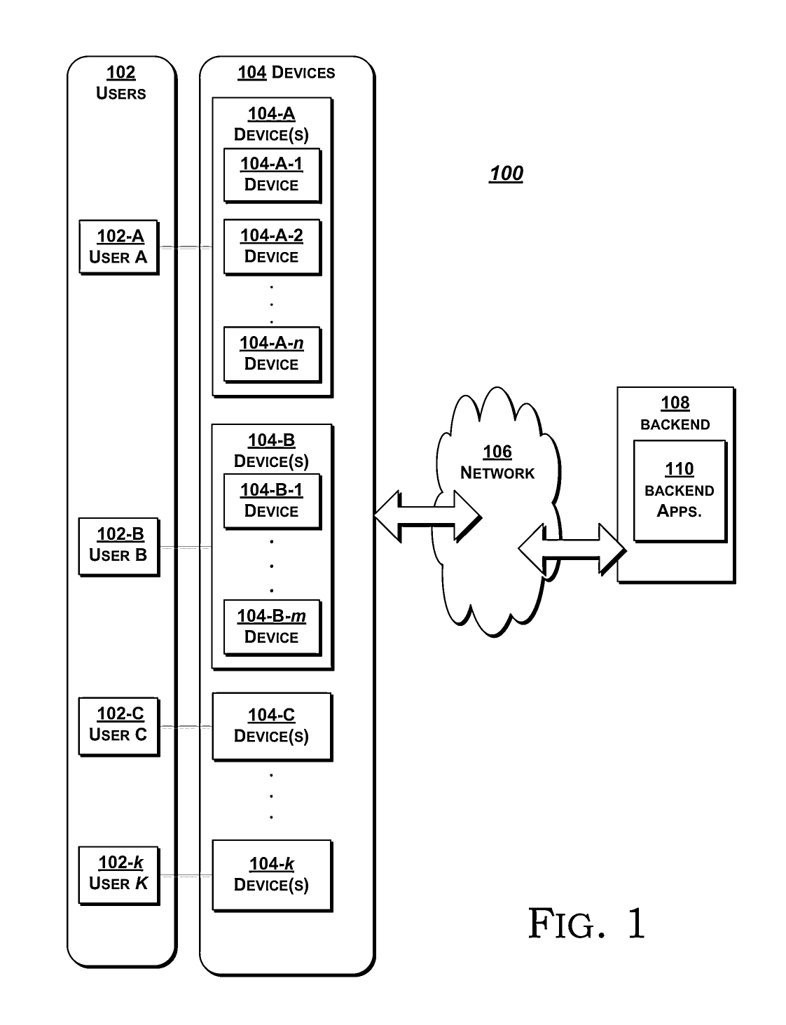

FIG. 1 shows an overview of an exemplary framework 100 for a communications system. Within the framework 100, a user 102 may have one or more devices 104 associated therewith. For example, as shown in FIG. 1, user 102-A has device(s) 104-A (comprising devices 104-A-1, 104-A-2 . . . 104-A-n) associated therewith. Similarly, user 102-B has device(s) 104-B (comprising devices 104-B-1 . . . 104-B-m) associated therewith. The association between the user and the devices is depicted in the drawing by a line connecting a user 102 with device(s) 104 associated with that user. Although only four user/device associations are shown in the drawing, it should be appreciated that a particular system may have an arbitrary number of users, each with an arbitrary number of devices.

It should be appreciated that a user 102 may not correspond to a person or human, and that a user 102 may be any entity (e.g., a person, a corporation, a school, etc.).

Users 102 may use their associated device(s) 104 to communicate with each other within or via the framework 100. A user's device(s) may communicate with one or more other users' device(s) via network 106 and a backend 108, using one or more backend applications 110. The backend 108 (backend application(s) 110) may act as a persistent store through which users 102 share data.

As will be described in greater detail below, an interaction between a set of one or more users 102 is referred to herein as a “conversation.” In some cases, a user may have a so-called “self-conversation,” in which case the user's device(s) may be considered to be communicating with each other. In the case of a self-conversation, the backend 108 may be considered to be acting as a persistent store within which a user maintains that user's self-conversation and through which that user's device(s) can view and participate in that user's self-conversation.

The devices 104 can be any kind of computing device, including mobile devices (e.g., phones, tablets, etc.), computers (e.g., desktops, laptops, etc.), and the like. Each device preferably includes at least at one display and at least some input mechanism. The display and input mechanism may be separate (as in the case, e.g., of a desktop computer and detached keyboard and mouse), or integrated (as in the case, e.g., of a tablet device such as an iPad or the like). The term “mouse” is used here to refer to any component or mechanism the may be used to position a cursor on a display and, optionally, to interact with the computer. A mouse may include a touchpad that supports various gestures. A mouse may be integrated into or separate from the other parts of the device. A device may have multiple displays and multiple input devices.

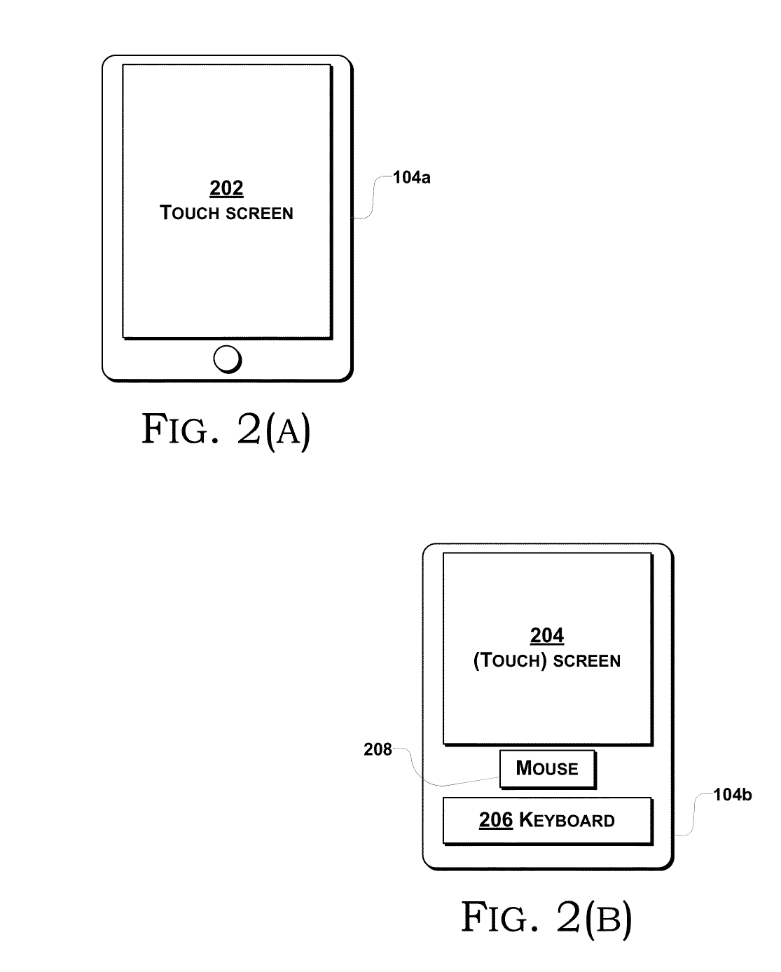

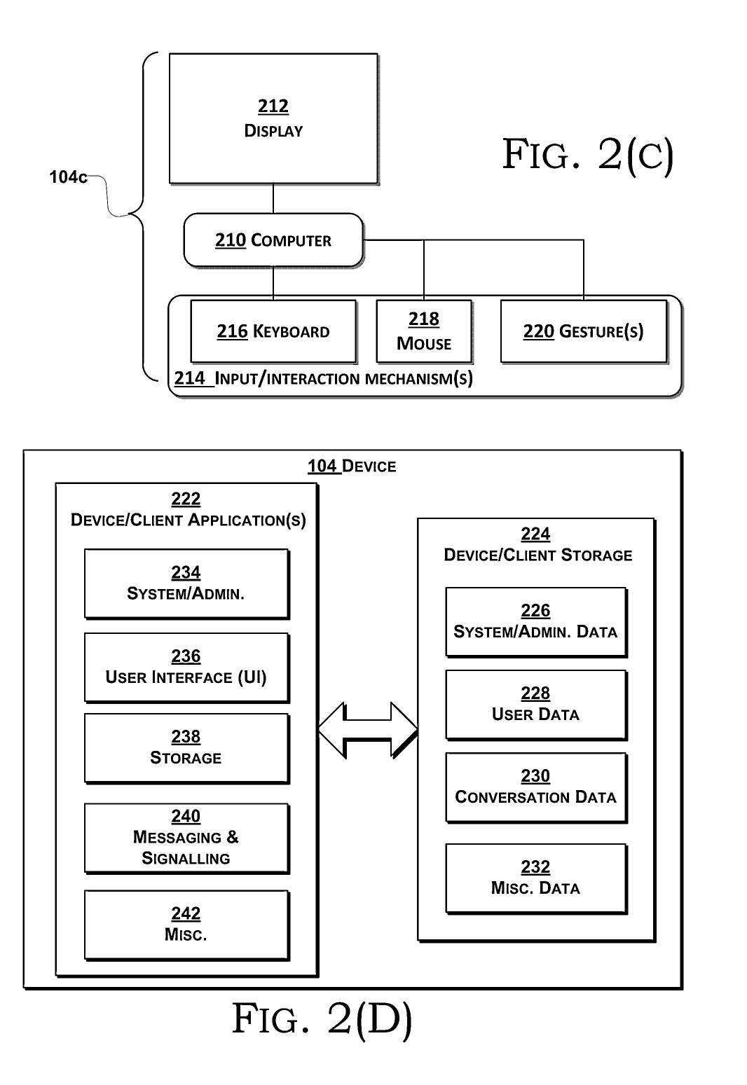

FIGS. 2(A)-2(C) show examples of devices 104a, 104b, and 104c, respectively, that may be used within the system/framework 100. These may correspond, e.g., to some of the devices 104 in FIG. 1. Exemplary device 104a (FIG. 2(A)) has an integrated display and input mechanism in the form of touch screen 202. The device 104a is integrated into a single component, e.g., a smartphone, a tablet computer, or the like. The device 104a may support a software (or virtual) keyboard (VKB). Exemplary device 104b (FIG. 2(B)) is also integrated into a single component, but, in addition to a screen 204 (which may be a touch screen), the device includes a keyboard 206 and an integrated mouse 208 (e.g., an integrated device such as a trackball or track pad or the like that supports movement of a cursor on the screen 204). The keyboard may be a hardware keyboard (e.g., as in the case of a BlackBerry phone). The screen 204 may be a touch screen and may support a virtual keyboard (VKB).

The exemplary device 104c (FIG. 2(C)) comprises multiple components, including a computer 210, a computer monitor 212, and input/interaction mechanism(s) 214, such as, e.g., a keyboard 216 and/or a mouse 218, and/or gesture recognition mechanism 220. Although the various components of device 104c are shown connected by lines in the drawing, it should be appreciated the connection between some or all of the components may be wireless. Some or all of these components may be integrated into a single physical device or appliance (e.g., a laptop computer), or they may all be separate components (e.g., a desktop computer). As another example, a device may be integrated into a television, a set top box, or the like. Thus, e.g., with reference again to FIG. 2(C), the display 212 may be a television monitor and the computer 210 may be integrated fully or partially into the monitor. In this example, the input/interaction mechanisms 214 (e.g., keyboard 216 and mouse 218) may be separate components connecting to the computer 210 via wired and/or wireless communication (e.g., via Bluetooth or the like). In some cases, the input/interaction mechanisms 214 may be fully or partially integrated into a remote control device or the like. These input/interaction mechanisms 214 may use virtual keyboards generated, at least in part, by the computer 210 on the display 212.

Those of ordinary skill in the art will realize and understand, upon reading this description, that the exemplary devices 104a and 104b in FIGS. 2(A)-2(B) may be considered to be instances of the device 104c shown in FIG. 2(C).

It should be appreciated that these exemplary devices are shown here to aid in this description, and are not intended to limit the scope of the system in any way. Other devices may be used and are contemplated herein.

FIG. 2(D) shows logical aspects of a typical device 104 (FIG. 1), including device/client application(s) 222 interacting and operating with device/client storage 224. Device/client storage 224 may include system/administrative data 226, user data 228, conversation data 230, and other miscellaneous data 232. The device/client application(s) 222 may include system/administrative application(s) 234, user interface (UI) application(s) 236, storage application(s) 238, messaging and signaling application(s) 240, and other miscellaneous application(s) 242. The categorization of data in storage 224 is made for the purposes of aiding this description, and those of ordinary skill in the art will realize and appreciate, upon reading this description, that different and/or other categorizations of the data may be used. It should also be appreciated any particular data may categorized in more than one way. Similarly, it should be appreciated that different and/or other categorizations of the device/client application(s) 222 may be used and furthermore, that any particular application may be categorized in more than one way.

Conversations

Recall from above that the term “conversation” is used herein to refer to an ongoing interaction between a set of one or more users. In some aspects, a conversation may be considered to be a time-ordered sequence of events and associated event information or messages. The first event occurs when the conversation is started, and subsequent events are added to the conversation in time order. The time of an event in a conversation is preferably the time at which the event occurred on the backend.

Events in a conversation may be represented as or considered to be objects, and thus a conversation may be considered to be a time-ordered sequence of objects. An object (and therefore a conversation) may include or represent text, images, video, audio, files, and other assets. As used herein, an asset refers to anything in a conversation, e.g., images, videos, audio, links (e.g., URLs or URIs) and other objects of interest related to a conversation. A conversation may also include system information and messages (which may be text). In some aspects, a conversation may be considered to be a timeline with associated objects.

An object may contain the actual data of the conversation (e.g., a text message) associated with the corresponding event, or it may contain a link or reference to the actual data or a way in which the actual data may be obtained. The link may be to another location in the system 100 (e.g., in the backend 108) or it may be external. For the sake of this discussion, a conversation object that contains the actual conversation data is referred to as a direct object, and a conversation object that contains a link or reference to the data (or some other way to obtain the data) for the conversation is referred to as an indirect or reference object. A direct object contains, within the object, the information needed to render that portion of the conversation, whereas an indirect object typically requires additional access to obtain the information needed to render the corresponding portion of the conversation. Thus, using this terminology, an object may be a direct object or an indirect object.

As used herein, the term “render” (or “rendering”) with respect to data refers to presenting those data in some manner, preferably appropriate for the data. For example, a device may render text data (data representing text) as text on a screen of the device, whereas the device may render image data (data representing an image) as an image on a screen of the display, and the device may render audio data (data representing an audio signal) as sound played through a speaker of the device (or through a speaker or driver somehow connected to the device), and a device may render video data (data representing video content) as video images on a screen of the device (or somehow connected to the device). The list of examples is not intended to limit the types of data that devices in the system can render, and the system is not limited by the manner in which content is rendered.

It should be appreciated that a particular implementation may use only direct objects, only indirect objects, or a combination thereof. It should also be appreciated that any particular conversation may comprise direct objects, indirect objects, or any combination thereof. The determination of which conversation data are treated as direct objects and which as indirect objects may be made, e.g., based on the size or kind of the data and on other factors affecting efficiency of transmission, storage, and/or access. For example, certain types of data may be treated as indirect objects because they are typically large (e.g., video or images) and/or because they require special rendering or delivery techniques (e.g., streaming).

As used herein, the term “message” refers to an object or its (direct or indirect) contents. Thus, for a direct object that includes text, the message is the text in that direct object, whereas for an indirect object that refers to an asset, the message is the asset referred to by the indirect object.

In a presently preferred implementation, conversations may use a combination of direct and indirect objects, where the direct objects are used for text messages (including system messages, if applicable) and the indirect objects are used for all other assets. In some cases, text messages may be indirect objects, depending on their size (that is, an asset may also include or comprise a text message). It should be appreciated that even though an asset may be referenced via an indirect object, that asset is considered to be contained in a conversation and may be rendered (e.g., displayed) as part of (or apart from) a conversation.

Each device should be able to render each asset in a conversation in some manner.

It should be appreciated that the assets in a conversation (i.e., the assets referenced by indirect objects in the conversation) may be of different types (e.g., audio, pictures, video, files, etc.), and that the assets may not all be of the same size, or stored in the same place or in the same way.

As used herein, a user participating in a conversation is said to be conversing or engaging in that conversation. The term “converse” or “conversing” may include, without any limitation, adding any kind of content or object to a conversation, and removing or modifying any kind of content or object within a conversation. It should be appreciated that the terms “converse” and “conversing” include active and passive participation (e.g., viewing or reading or listening to a conversation). It should further be appreciated that the system is not limited by the type of objects in a conversation or by the manner in which such objects are included in or rendered within a conversation.

The User Interface (UI)

Clients (users' devices 104) interact with each other and the system 100 via the backend 108. These interactions generally take place, at least in part, using a user interface (UI) provided/supported by UI application(s) 236 (FIG. 2(D)) running on each client (device 104, FIG. 1).

A user of a device 104 uses the UI on that device to interact with other applications on the device. In a general case, a user's interaction with the UI causes the UI to provide information (e.g., instructions, commands, or any kind of input) to other applications. And other applications' interactions with the UI cause the UI to present information to the user (e.g., on the screen of the device 104, via an audio system associated with the device, etc.).

A UI is implemented, at least in part, on a device 104 using UI application(s) 236 on that device, and preferably uses the device's display(s) and input/interaction mechanism(s) (e.g., 214, FIG. 2(C)). Use of a UI may require selection of items, navigation between views, and input of information. It should be appreciated that different devices may support different techniques for presentation of and user interaction with the UI. For example, a device with an integrated touch screen (e.g., device 104a as shown in FIG. 2(A)) may display UI information on the touch screen 202, and accept user input (for navigation, selection, input, etc.) using the touch screen (e.g., with a software/virtual keyboard—VKB—for some types of input). A device with an integrated screen, keyboard, and mouse (e.g., device 104b as shown in FIG. 2(B)) may display UI information on the screen 204, and accept user input using the hardware keyboard 206 and hardware mouse 208. If the screen/display 204 is also a touch screen display, then user interactions with the UI may use the screen instead of or in addition to the keyboard 206 and mouse 208. A device with separate components (e.g., some instances of device 104c of FIG. 2(C)) may display UI information on the display 212 and accept user input to the UI using input/interaction mechanism(s) 214 (e.g., the keyboard 216 and/or mouse 218 and/or gesture mechanism 220).

As used herein, the UI provided/supported by the UI application(s) 236 is sometimes referred to herein as the UI 236.

UI Interactions

A UI presents information to a user, preferably by rendering the information in the form of text and/or graphics (including drawings, pictures, icons, photographs, etc.) on the display(s) of the user's device(s). The UI 236 preferably includes or has access to rendering mechanism(s) appropriate to the various kinds of data it may be required to render. For example, the UI 236 may include or have access to one or more mechanisms for text rendering, image rendering, sound rendering, etc. These rendering mechanisms may be included in the device/client application(s) 222.

The user may interact with the UI by variously selecting regions of the UI (e.g., corresponding to certain desired choices or functionality), by inputting information via the UI (e.g., entering text, pictures, etc.), and performing acts (e.g., with the mouse or keyboard) to affect movement within the UI (e.g., navigation within and among different views offered by the UI).

The UI application(s) 236 (FIG. 2(D)) preferably determine (or know) the type and capability of the device on which it is running, and the UI may vary its presentation of views depending on the device. For example, the UI presented on a touch screen display on a smartphone may have the same functionality as the UI presented on the display of general-purpose desktop or laptop computer, but the navigation choices and other information may be presented differently.

It should be appreciated that, depending on the device, the UI 236 may not actually display information corresponding to navigation, and may rely on unmarked parts of the screen and/or gestures to provide navigation support. For example, different areas of a screen may be allocated for various functions (e.g., bottom for input, top for search, etc.), and the UI may not actually display information about these regions or their potential functionality. It should be appreciated that the functionality associated with a particular area or portion of a display screen may change, e.g., depending on the state of the UI.

As has been explained, and as will be apparent to those of ordinary skill in the art, upon reading this description, the manner in which UI interactions take place will depend on the type of device and interface mechanisms it provides.

As used herein, in the context of a UI, the term “select” (or “selecting”) refers to the act of a user selecting an item or region of a UI view displayed on a display/screen of the user's device. The user may use whatever mechanism(s) the device provides to position the cursor (which may or may not be visible) appropriately and to make a desired selection. For example, a touch screen 202 on device 104a may be used for both positioning and selection, whereas device 104b may require the mouse 208 (and/or keyboard 206) to position a cursor on the display 204 and then to select an item or region on that display. In the case of a touch screen display, selection may be made by tapping the display in the appropriate region. In the case of a device such as 104c, selection may be made using a mouse click or the like.

Touch Screen Interfaces and Gestures

Touch-screen devices (e.g., an iPad, iPhone, etc.) may recognize and support various kinds of touch interactions, including gestures, such as touching, pinching, tapping, and swiping. These gestures may be used to move within and among views of a UI.

Views

In a presently preferred implementation, the UI (implemented, e.g., using UI interface application(s) 236 on device 104) comprises a number of views. These views may be considered to correspond to various states that the device/client application(s) 222 may be in, and, in a preferred embodiment, include a conversation view that provides a device user with views of conversations in which the user is a participant. The conversation view is the view or GUI where discussions, messages, exchange of objects, and the like may take place in the system 100. The user may navigate (e.g., move around) within the conversation view, and may navigate to/from the conversation view from/to other views of the GUI.

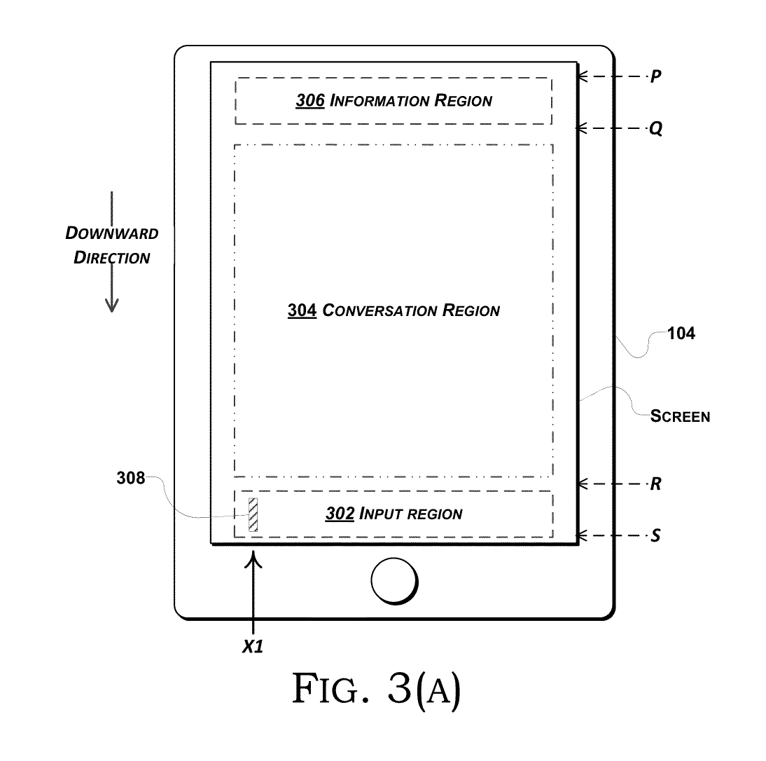

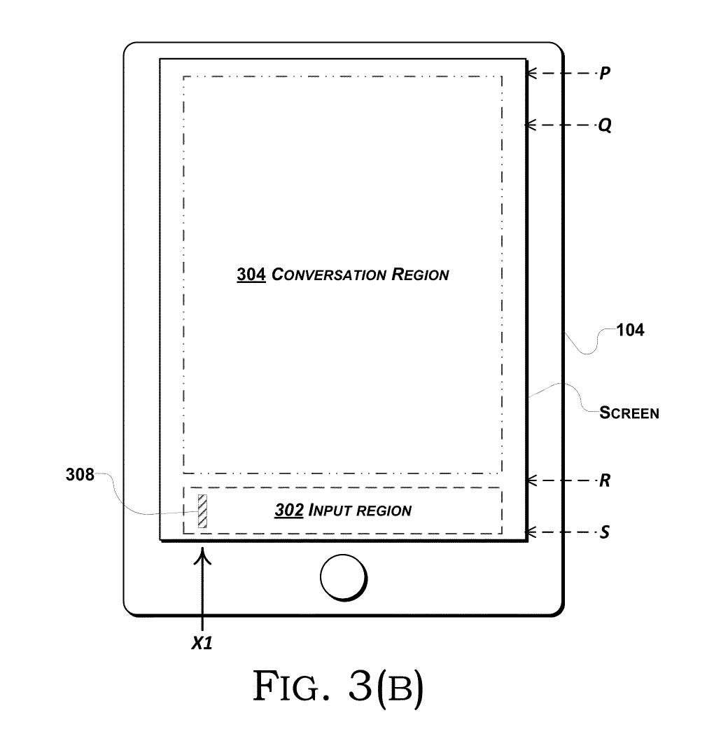

FIGS. 3(A)-3(B) show exemplary conversation views 300 of a UI supported/provided by user interface (UI) application(s) 236 of a device 104. The conversation views 300 may be displayed on the display mechanism of the device (e.g., touch screen 202 of exemplary device 104a in FIG. 2(A), screen 204 of exemplary device 104b in FIG. 2(B), display 212 of exemplary device 104c in FIG. 2(C), etc.). In FIGS. 3(A)-3(B) the conversation view is shown on the screen of device 104. In order to simplify the drawings, and for the sake of explanation, in subsequent drawings, the display mechanism (e.g., screen) and other features of the underlying device on which the conversation view is displayed are not shown.

With reference to the drawing in FIG. 3(A), an exemplary conversation view 300 comprises an input region 302 (shown at the bottom of the display screen), a conversation region 304, and (optionally) an information region 306. The information region 306 may provide, e.g., a caption or subject for the conversation and/or it may list the conversation participants. In some cases the information region 306 may be omitted (as shown in FIG. 3(B)). In the drawings the various regions are shown with dashed lines indicating their positions on the display. It should be appreciated that in preferred implementations, the actual regions are not outlined or highlighted on the display.

In preferred implementations the input region 302 is indicated or designated by a cursor 308 (e.g., a vertical bar rendered on the left side of the input region 302, shown at horizontal position X1 in FIG. 3(A)). For languages that are written from right to left, the cursor 308 may default to a position on the right side of the input region 302.

With reference to FIG. 3(A), the input region 302 may use an area on the bottom of the screen (between vertical positions R and S), the conversation region 304 uses an area of the screen between vertical positions Q and R, and the information region 306 (if present) uses an on the top of the screen (between vertical positions P and Q).

In other embodiments, the positions of the input region 302 and/or information region 306 may be in alternate positions (e.g., both at the top, both at the bottom, or in exchanged positions).

The Conversation Region View

Recall (as described above) that a conversation comprises a time-ordered sequence of events. The conversation view may be used to provide a sliding window over a conversation. In preferred implementations, the conversation view provided by the UI application(s) 236 can be used to view some or all of a conversation.

For example, as shown in FIG. 3(C), an exemplary conversation 310 comprises the time-ordered sequence of objects:

[Object₁, . . . Object_{A-1}, Object_{A}, Object_{A+1} . . . Object_{M} , Object_{M+1} . . . Object_{z}]

where, for the sake of this discussion, Object₁ is the first object in the conversation and Object_{Z} is the last (or most recent object) in the conversation. That is, Object₁ was the first event to occur in this conversation 310, and Object_{Z} was the most recent event to occur in conversation 310.

A conversation window 312 of the exemplary conversation 310 may be used to view a portion of conversation 310. The start time (Tₛₜₐᵣₜ) of the period covered by the conversation window 310 can be varied, as can the duration (D=T_{end}−Tₛₜₐᵣₜ) of the time period.

A view of a region or portion of a conversation provides a view of objects (e.g., messages, etc.) within that region or portion. Thus, e.g., the conversation window 312 provides a view of messages associated with objects within the window (Object_{A}, Object_{A+1} . . . Object_{M} in the example in FIG. 3(C)). As shown in the example in FIG. 3(C), there may be other objects in the conversation that are not covered by the current window (e.g., objects Object₁, . . . Object_{A-1} in the time before Tₛₜₐᵣₜ, and objects Object_{M+1} . . . Object_{Z} in the time after T_{end}).

Preferably, messages are listed top-bottom in reverse order of recency, with the most recent being closer to the input field at the bottom of the UI screen. In operation, as new messages arrive/are sent, the older ones are pushed upwards.

The conversation window 312 in FIG. 3(C) may be viewed in the conversation region 304 provided/supported by the UI application(s) 236 in FIGS. 3(A)-3(B). In other words, the conversation region 304 in the conversation view 300 of the UI provided by the UI application(s) 236 may be used to view a portion of a conversation 310 defined by a conversation window 312.

The user may use the conversation view 300 provided/supported by the UI application(s) 236 to effectively move the conversation window 312 up or down within the conversation 310 in order to view different parts of the conversation 310. The user may also use the conversation view 300 provided/supported by the UI application(s) 236 to vary the duration covered by the conversation window 312 to provide for views of larger (longer) portions of the conversation 310.

The conversation view 300 may include regions which, when selected, cause different portions of a selected conversation to be viewed. In some other implementations, e.g., those implemented on touch-screen devices, transition from one view of a conversation to another may be affected or caused by touching the screen in various manners. Similarly, in such implementations, transition from the conversation view 300 to one of the other views may be affected or caused by touching the screen in various manners.

Scrolling in a Conversation

When a user opens conversation on a device, the conversation view 300 provided by the UI application(s) 236 preferably corresponds to the view shown in FIG. 3(A) (or FIG. 3(B)), with the conversation window 312 of that conversation preferably including at least the most recent object (e.g., Object_{Z} in the conversation 310 in FIG. 3(C)).

Using the UI provided by the UI application(s) 236, the user may scroll back to earlier events in the conversation (thereby effectively sliding the conversation window over a different time period of the conversation). The user may scroll in some known manner that may depend on the type of the device, e.g., by swiping within the conversation region 304 on the conversation view 300 displayed on a touch screen of a device 104.

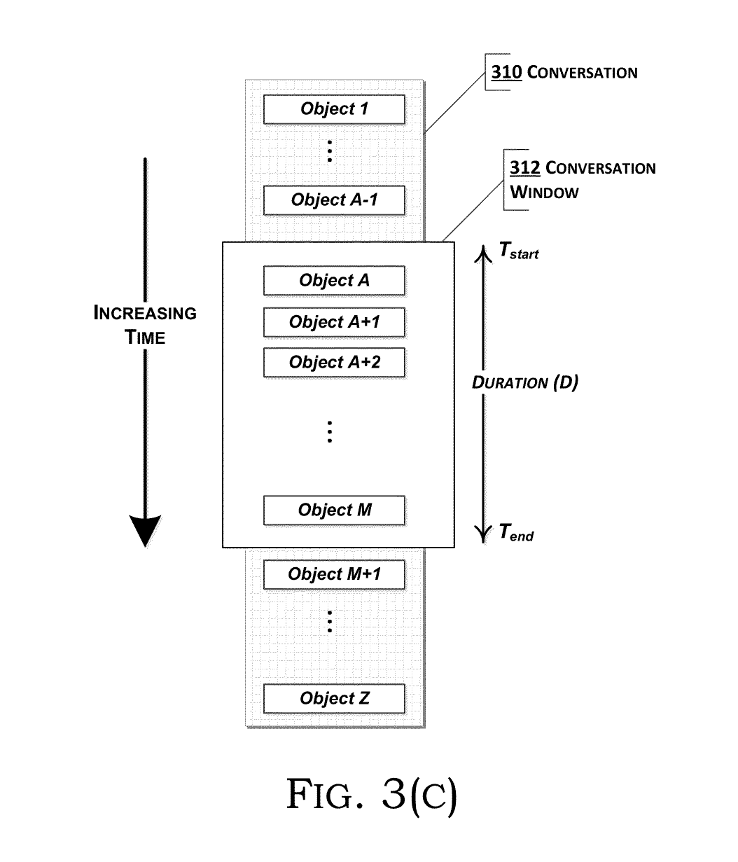

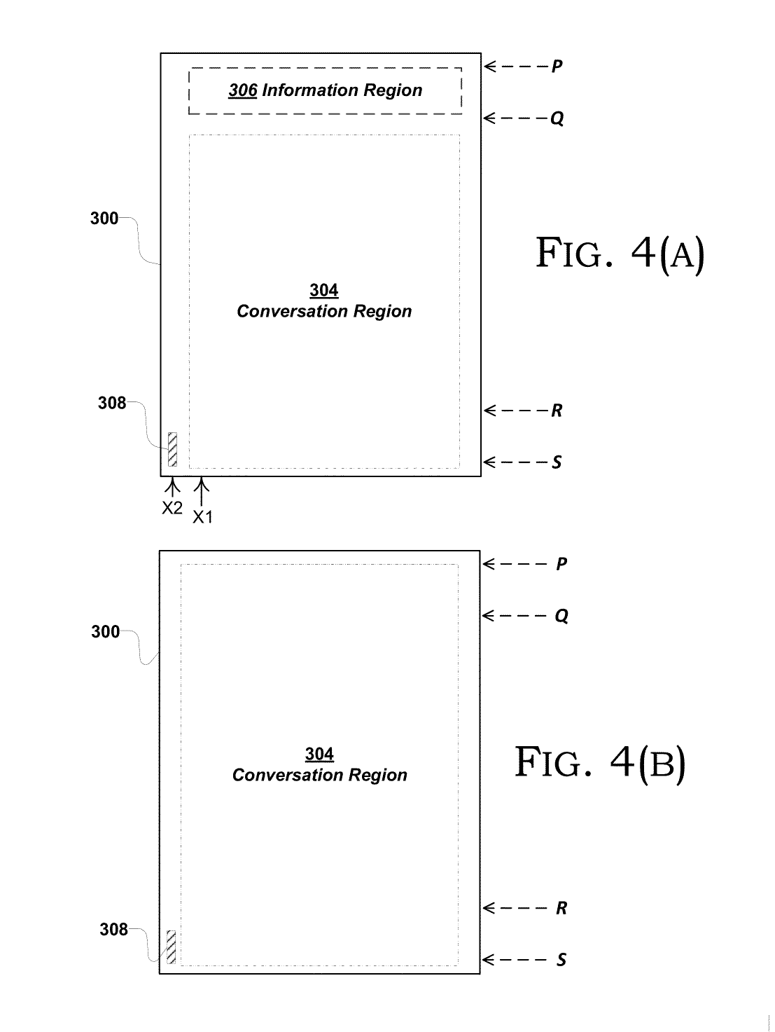

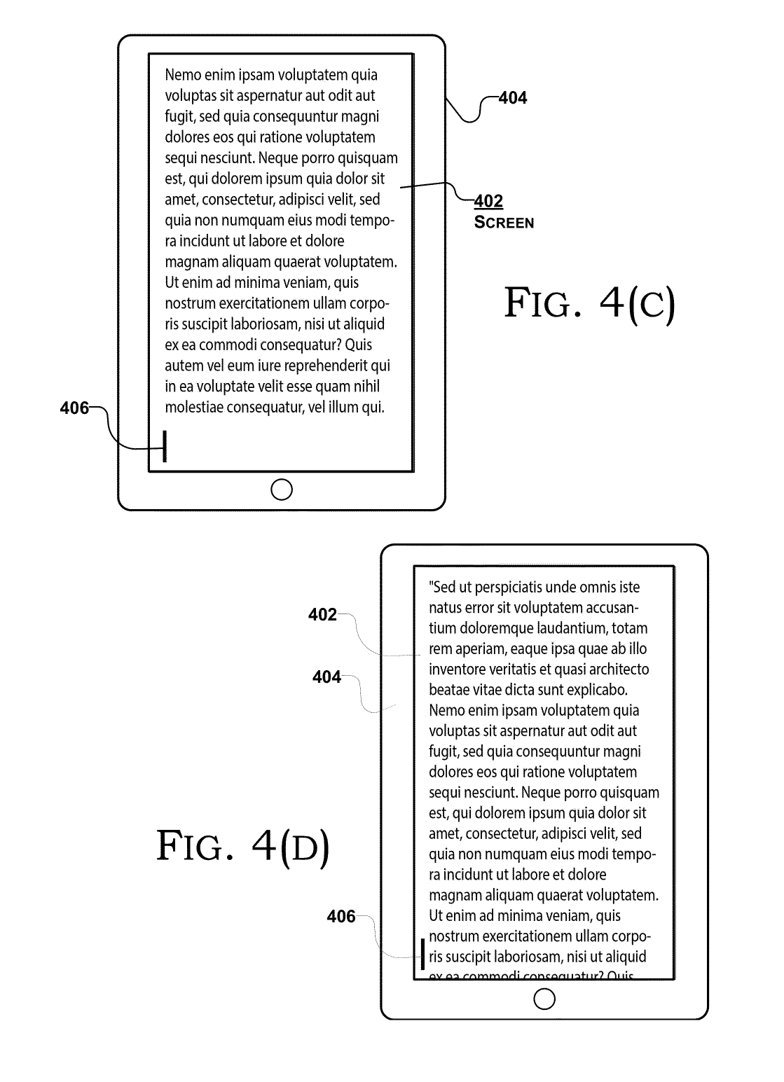

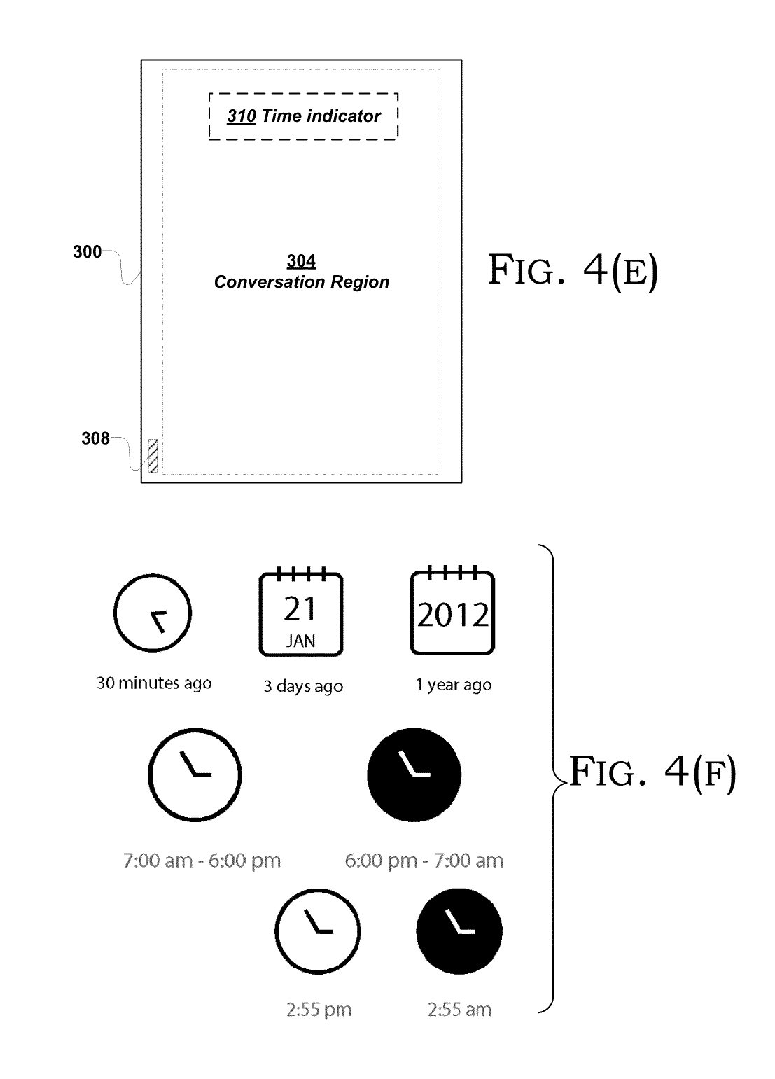

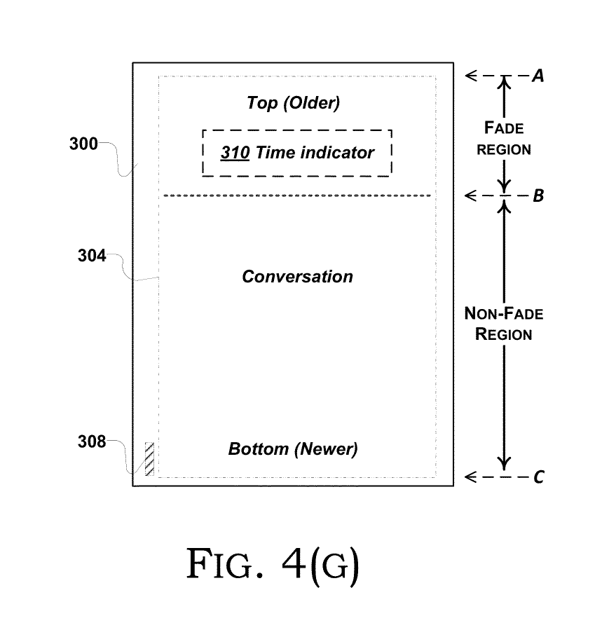

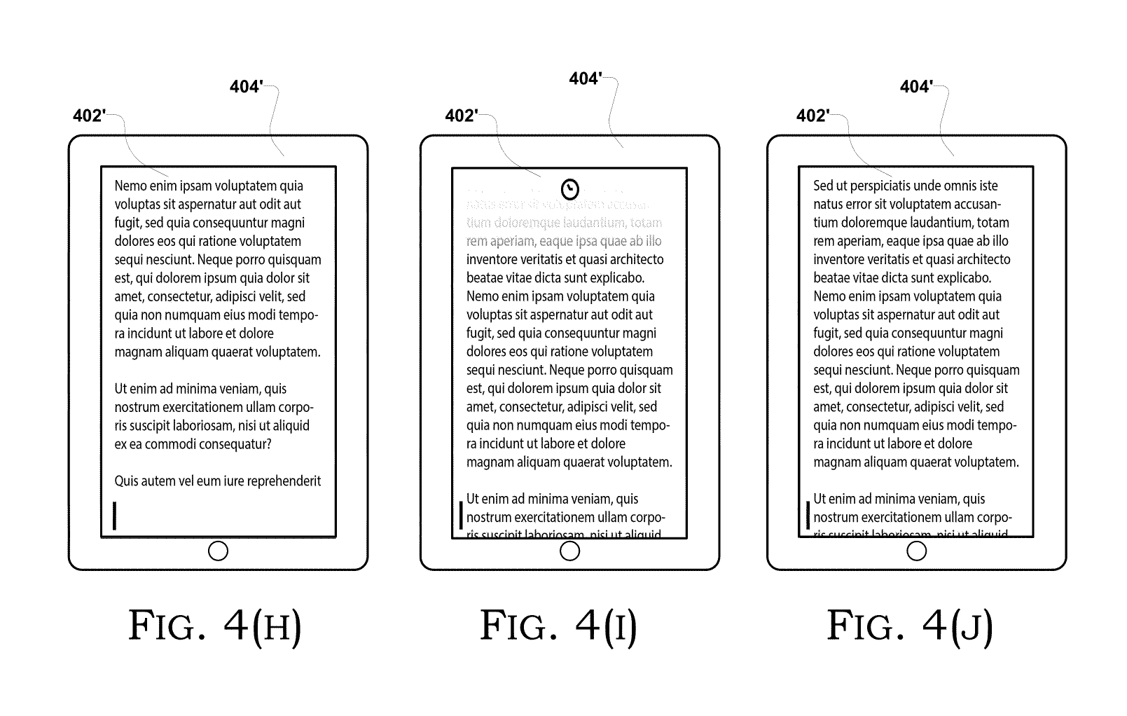

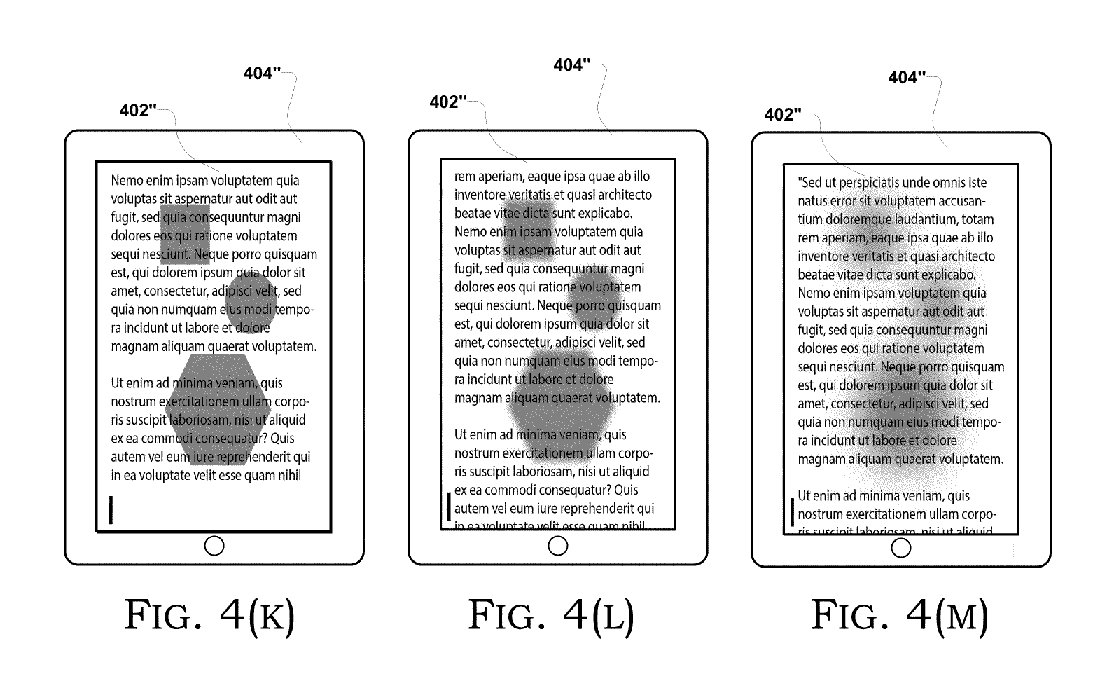

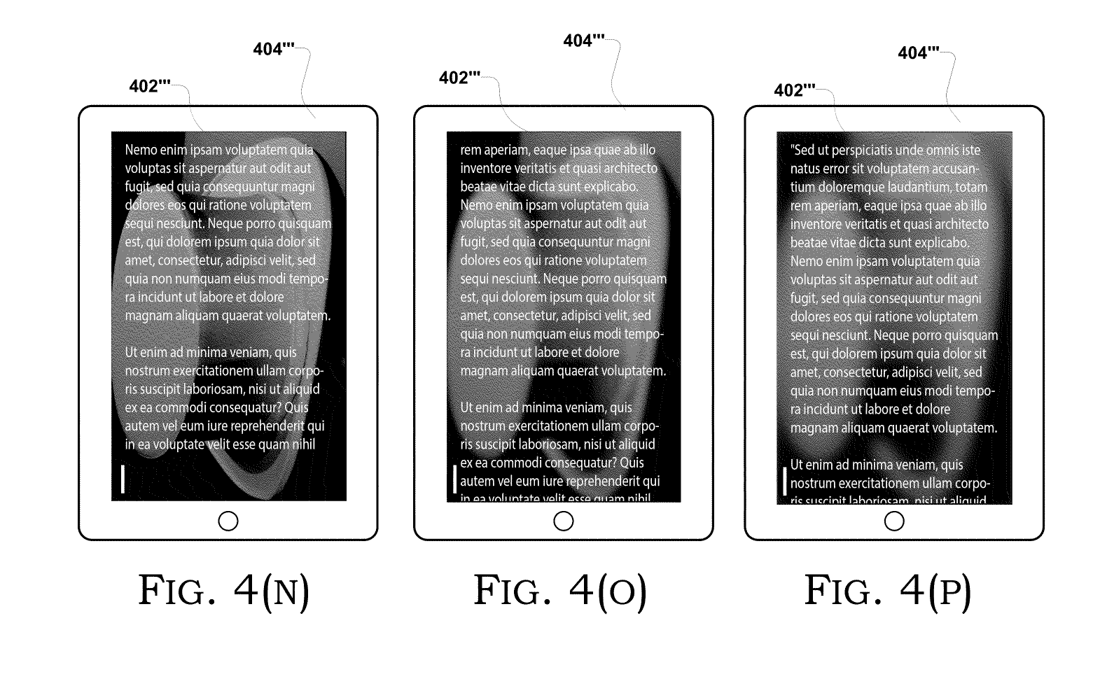

The inventors realized that the UI may use different parts of the screen in different ways and for different purposes, depending on the state of the UI. In particular, the inventors realized that, under certain conditions and in certain states, e.g., when scrolling, it is not always necessary for the UI to retain the input region 302 on the conversation view (i.e., on a device's screen). For example, they realized that when the conversation window 312 no longer includes the most recent object (e.g., Object_{Z} in the conversation 310 in FIG. 3(C)), then the conversation view 300 need not include an active input region 302. Accordingly, as shown in FIG. 4(A), when the user scrolls in a conversation, the UI provided by the UI application(s) 236 may expand the area used by the conversation region 304 to include some or all of the area that was used by the input region 302, i.e., to use some or all of the region between vertical positions R and S (that was used by the input region 302). In this manner the UI provided by the UI application(s) 236 uses more of the screen space to render the conversation, and unused space (for a region that would not be used in this state) is not wasted.

In a preferred implementation, when the UI provided by the UI application(s) 236 expands the conversation region 304, the cursor 308 is moved aside (e.g., to the left) so as not to be within or in the way of the expanded/expanding conversation region 304. In the example shown in FIG. 4(A), the cursor 308 is moved horizontally to the left (from horizontal position X1 to horizontal position X2 (left of position X1, and outside the left boundary of the conversation region).

The cursor 308 may be moved aside in an animated manner, e.g., by a smooth motion or discrete motion. It should be appreciated that, in addition to providing more screen space to display the conversation, having the cursor 308 on the side of the conversation region 304 may provide an indication to the user that the conversation view is not of the most recent events in the conversation.

When the user scrolls back down in the conversation, e.g., to a conversation window that includes the most recent event, then the conversation region 304 may be reduced in size so that the input region 302 can again be used. When the size of the conversation region 304 is reduced, the cursor 308 may move back (e.g., to the right) to its position under the conversation region (e.g., horizontal position X1, to the right of the outside left boundary of the conversation region 304). In addition to exposing (and activating) the input region 302, moving the cursor back provides an indication to the user that the conversation view includes the most recent event.

In some implementations the cursor 308 may already be outside the left (or right) margin of the conversation region 304, in which cases there is no need to move the cursor to the left (or right) in order to expand the conversation region 304 over the input region 302.

In some implementations the conversation region 304 may expand to include less than the entire input region 302, while in some implementations the conversation region 304 may expand to include more than the entire input region 302.

As noted above, the information region 306 may include, e.g., caption information or the like. In some implementations, e.g., as shown in FIG. 4(B), during scrolling the conversation region 304 may be expanded vertically to include some or all of the area used by the information region 306. In this manner, the UI provided by UI application(s) 236 may sometimes use some or all of the area between vertical positions P and Q as part of the conversation region 304. Preferably this expansion is made during scrolling (though it may be maintained when scrolling ends, depending on the time period covered by the current view of the conversation).

The UI provided by UI application(s) 236 may thus, in some embodiments, determine which size to use for the conversation region 304 (and whether or not to deactivate the input region 302), depending on what time range is covered by the conversation window.

Those of ordinary skill in the art will realize and understand, upon reading this description, that a particular UI implementation may expand the conversation region 304 into either or both of some or all of the information region 306 and the input region 302. Thus, in some embodiments, the conversation region 304 may expand to use a portion of the information region 306 while also expanding to use a portion of the input region 302. In some cases, the conversation region 304 may expand to use a portion of the information region 306 without also expanding to use a portion of the input region 302, or vice versa.

In some embodiments, the cursor 308 may not be shown when the conversation region 304 is expanded, and it is shown when the conversation region includes the most recent object in the conversation.

FIGS. 4(C)-4(D) show an example conversation in a conversation view 300 in an implementation, in which a cursor moves to the left during scrolling. It should be appreciated that the text shown in all example conversations is given by way of example and is not intended to limit the scope of the system in any way. As is apparent from the drawings, the example UI shown in FIGS. 4(C)-4(D) does not include an information region.

In this example, as shown in FIGS. 4(C)-4(D), a portion of a conversation is presented by the UI application(s) 236 on the screen 402 of device 404. The device 404 may be, e.g., a device such as device 104a shown in FIG. 2(A), where the screen 402 may correspond to the touch screen 202 of that device. As shown in the UI view in FIG. 4(C), a cursor 406 (corresponding, e.g., to cursor 308 in FIG. 3(A)) is positioned on the left side of the screen 402, under the conversation. In the state depicted in FIG. 4(C), the input region of the UI is active, and the portion of the conversation being presented includes the most recent conversation event.

FIG. 4(D) depicts a view of the conversation shown in FIG. 4(C), where the user has scrolled the conversation to view an earlier portion. In this view the portion of the conversation being presented by the UI no longer includes the most recent conversation event, and the cursor 406 has been moved to the left, allowing the conversation region to expand to include at least a portion of the input region. In this view (FIG. 4(D)) the entire input region is no longer active (although, in some cases, it may be activated by selecting the cursor 406).

Those of ordinary skill in the art will realize and appreciate, upon reading this description, that when the conversation region is enlarged to cover a portion (some or all) of the input region, then at least the portion of the input region that is covered by the conversation region becomes inactive. The input region may become active again when the conversation view includes the most recent event. In some embodiments the user may activate the input region by selecting (e.g., tapping) the input cursor, effectively causing the conversation view to jump to the most recent conversation event.

When the conversation region has expanded (e.g., during scrolling) to include a portion of the input region, the conversation region preferably retains an enlarged size as long as the conversation window does not include the most recent conversation event. Thus, the conversation region may remain enlarged after scrolling ends.

The portions of the conversation included in the conversation window during scrolling may be stored in the device/client storage 224 on the device. Portions (some or all) of the conversation may be obtained from the backend 108 as needed or they may have already been stored on the device.

Size and Scale

Although the various regions (input region 302, conversation region 304, and information region 306) are shown in the drawings as having gaps between them, it should be appreciated that in an actual implementation, there may not be gaps between some or all regions, and some or all of the regions may abut adjacent regions. It should also be appreciated that the regions in the drawings are not drawn to scale and that the relative sizes of the regions in the drawings are exemplary and not limiting.

It should be appreciated that the display of a device may not all be usable by an application. E.g., there may be a boundary around the edges of the display that are not considered usable by applications running on the device. It should therefore be appreciated that, as used herein, including in the claims, the term “uses x% of the height/width/area of the screen the device” for some value x means “uses x% of the usable part of the height/width/area of the screen of the device.” So, e.g., the phrase “uses 95% of the screen of the device” means “uses 95% of the usable part of the screen of the device.” Similarly, the term “has a height/width/area of Y% of the screen of the device” for some value Y means “has a height/width/area of Y% of the usable part of the screen of the device.”

In one preferred implementation, where the device is a mobile phone (an Apple iPhone 5), the input region is at the bottom of the conversation view and has a height of about 11% of the screen of the device (128 pixels high, out of 1,136 pixels). In this preferred implementation the information region, if provided, is at the top of the conversation view and has a height of about 10% of the height of the screen of the device. In this implementation, the conversation region has a height (when the information region is displayed) of about 79% of the height of the screen of the device, filing the rest of the conversation view. In another preferred implementation, no information region is provided, and when the input region is active the conversation region uses about 79% of the screen, with the input region using about 11% of the screen. In these embodiments, when the conversation region is enlarged, it reclaims about 11% of the screen that was being used by the input region.

When the input region 302 is deactivated and not displayed (e.g., as in FIG. 4(B)), the conversation region 304 uses substantially all of the screen of the device (at least 90%, preferably at least 95%, more preferably at least 99% of the height of the screen of the device).

In the preferred implementation, the width of the conversation region 304 is substantially the width of the screen of the device (at least 90%, preferably at least 95%, more preferably at least 99% of the width of the screen of the device).

In presently preferred embodiments, the input region uses about 10-15% of the screen, and, when the conversation region expands it expands to use all or substantially all of the input region, thus expanding by about 10-15% of the screen. Where no information region is provided, the conversation region uses about 85-90% of the screen, and may expand to use about 100% of the screen.

Time Indication

When a user scrolls within a conversation, the UI may display time information, providing the user with an indication of the time associated with the conversation events being viewed. With reference again to FIG. 3(C), the time information preferably corresponds to information about the period Tₛₜₐᵣₜ to T_{end}. For example, as shown in FIG. 4(E), a time indicator 310 may be displayed over the conversation region 304. The time indicator 310 may specify an actual date/time or date/time range (e.g., “2:55 pm” or “7 am-6 pm” or “Yesterday, 4 pm”) or a relative time (e.g., “1 hour ago”, “2 days ago”, “last week”, “5 years ago”, “about 25 minutes ago”, etc.). The time indicator 310 may, in addition to or instead of a textual indication, provide a pictographic or iconic representation of the time. FIG. 4(F) shows some exemplary time indicators.

As used herein, the term “display X over Y” means to display X at least partially covering Y. Thus, e.g., when the time indicator 310 is displayed over the conversation region 304, this means that the time indicator 310 is displayed at least partially covering the conversation region 304. In preferred embodiments, the time indicator 310 is fully within and over the conversation region 304 (i.e., preferably no part of the time indicator 310 is outside the conversation region 304).

When the time indicator 310 is displayed over the conversation region 304, it may cover at least some of the content of the conversation region 304 (e.g., text, images, messages, etc.). In some embodiments the time indicator may be partially transparent, so that content that it is covering in the conversation region may be partially visible.

While the system preferably stores the date and time of each event in each conversation, during scrolling the time and/or date may be presented with rougher granularity. For example, in some implementations, any time in the past 24 to 48 hours may be presented as “1 day ago”.

When the UI uses pictographic or iconic representations, these may provide a rough indication of the time/date, even if that information is also provided textually. For example, a solid black icon may be used to represent nighttime, whereas a solid white icon may be used to represent daytime.

In some embodiments a time indicator 310 may be displayed during active scrolling (e.g., while the display is moving) and for a period of time after scrolling ends, and then be removed from the display. Preferably a time indicator 310 is displayed while the user is actually scrolling, so as to provide an indication to the user of the time (or time period) that is being presented by the UI in the conversation region 304. In some implementations, once the user has stopped scrolling for some period of time (e.g., 1 to 2 seconds), the time indicator 310 may be removed from the display. Preferably the UI retains the time indicator 310 over the conversation for a short predetermined time period, e.g., 1 to 2 seconds, although other lengths of time are contemplated and are within the scope of the invention.

The UI 236 may determine that the user is no longer scrolling either because the user has disengaged from the UI (e.g., lifted his finger of the touch screen), or because the user has stopped the view over a particular time period for more than a predetermined period of time (e.g., 1 to 2 seconds).

Although shown in the drawings near the top portion of the conversation region 304, it should be appreciated that the time indicator 310 may be elsewhere in the region, e.g., approximately in the middle of the conversation region or even below the mid-line of that region.

Shading and/or Blurring While Scrolling

By convention, the top part of the conversation region 304 represents older information than the bottom part of that region. (The UI 236 may be modified to have the oldest information at the bottom of the region and the newest at the top.)

In some embodiments, during scrolling, the UI 236 may present the older conversation information in a faded or dimmed view (relative to the most recent conversation information being displayed). Once the scrolling is stopped, the faded or dimmed portion of the conversation region 304 is displayed without any fading or dimming (i.e., the entire conversation region 304 is displayed with the same intensity).

As used herein, the term “faded” or “dimmed” means displayed with a lower intensity, relative to the intensity of the other information. It should be appreciated, however, that any way of displaying the older information such that it can be distinguished form the more recent displayed information may be used. For example, older information may be displayed in with a different background color and/or blurred (or defocussed).

When a time indicator 310 is used, the conversation information displayed in the conversation region 304 underneath the time indicator 310 is preferably dimmed or faded during scrolling, and the fading or dimming is ended when the time indicator 310 is removed.

In some embodiments the UI 236 presents or renders the conversation view 300 over a background (e.g., an image). In such cases, portions of the background may be dimmed or faded and/or blurred along with (or instead of) the conversation information being displayed above those portions.

With reference to the conversation view 300 in FIG. 4(G), the portion of the conversation region 304 with the older conversation events (between vertical positions A and B) may be referred to here as a “fade region,” while the remainder of the conversation region 304 (between the vertical positions B and C) may be referred to here as a “non-fade region.” In some embodiments, during scrolling, the UI 236 dims or fades the fade region of the conversation region 304 (with or without the time indicator 310 being displayed). While the fade region is dimmed, the non-fade region is displayed at a normal intensity. Once scrolling has ended for at least a predetermined period of time (e.g., 1 to 2 seconds), the UI 236 presents the fade region at the same intensity as the non-fade region.

In implementations that blur a portion of the conversation background, the background may remain blurred when the scrolling stops and does not include the most recent conversation object.

When fading is used, the conversation being rendered in the fade region is preferably faded continuously (as opposed to discretely) with decreasing intensity higher in the fade region. That is, preferably the fade region is displayed at a lower intensity than the non-fade region; with the intensity decreasing in the fade-region continuously from vertical position B to vertical position A.

When blurring is used, the background image is preferably blurred continuously (as opposed to discretely) with increased blurring as the conversation is scrolled to older portions of the conversation.

In a presently preferred embodiment, the fade region begins (at vertical position B) below or at the bottom of the time indicator 310.

When a time indicator 310 is displayed during scrolling, the UI 236 may un-fade the fade region (i.e., present that region at normal intensity) when the time indicator is removed (as described above).

As used herein, the term “normal intensity” refers to the intensity of the information displayed without any dimming or fading.

It should be appreciated that a particular implementation of a UI may use fading of the conversation content and/or blurring of the conversation background image during scrolling.

### EXAMPLES

### Fading Example

FIGS. 4(H)-4(J) show an example of a conversation view in an implementation, in which a top region of the conversation region fades during scrolling. In FIG. 4(H), the conversation is shown on screen 402′ of device 404′. In FIG. 4(I), the conversation is scrolled so that the most recent event is not shown. FIG. 4(I) shows a view presented by the UI during scrolling. In this view a portion of the conversation (i.e., the conversation content) is dimmed or faded and a time indication is shown. FIG. 4(J) shows the same view of the conversation as shown in FIG. 4(I) after scrolling ends. As shown in FIG. 4(J), the faded region is again shown at full or substantially full intensity, and the time indicator is no longer displayed.

### Blurring Examples

FIGS. 4(K)-4(M) show an example of a conversation view in an implementation, in which the UI blurs the background image(s) during scrolling. In FIG. 4(K) the background image (comprising a square, a circle, and a hexagon) shown on the screen 402″ of device 404″ is shown without blurring while the conversation shows the most recent object. As shown in FIGS. 4(L)-4(M), the background image becomes more blurred as the conversation view moves back in time. The view in FIG. 4(M) includes older conversation information than shown in the view in FIG. 4(L).

FIGS. 4(N)-4(P) show another example of a conversation background image being blurred during scrolling. In this example, the background image (a photograph of a hat) shown on the screen 402″′ of device 404″′ is blurred during scrolling. As with the previous example, the background image becomes more blurred as the conversation view moves further back in time (the view in FIG. 4(P) includes older conversation information than shown in the view in FIG. 4(O)).

An exemplary approach to message presentation and scrolling is described. Those of ordinary skill in the art will realize and appreciate, upon reading this description, that different and/or other approaches may be used within a UI, and the system is not to be limited in any way by the approach(es) described here.

### Computing

The services, mechanisms, operations and acts shown and described above are implemented, at least in part, by software running on one or more computers or computer systems or user devices (e.g., devices 104a, 104b, 104c in FIGS. 2(A)-2(C), respectively). It should be appreciated that each user device is, or comprises, a computer system.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

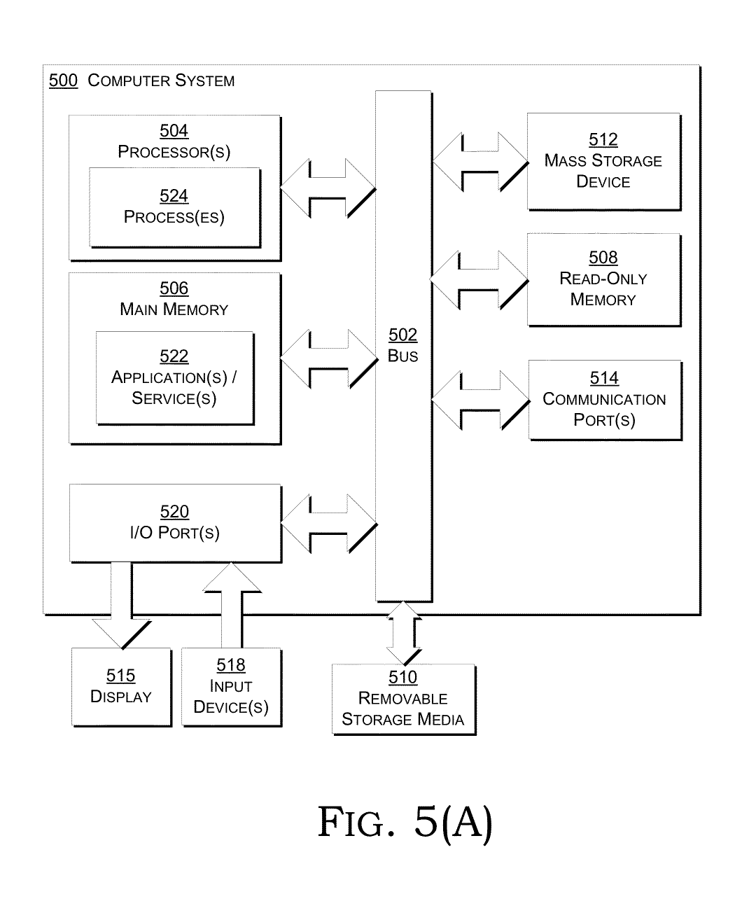

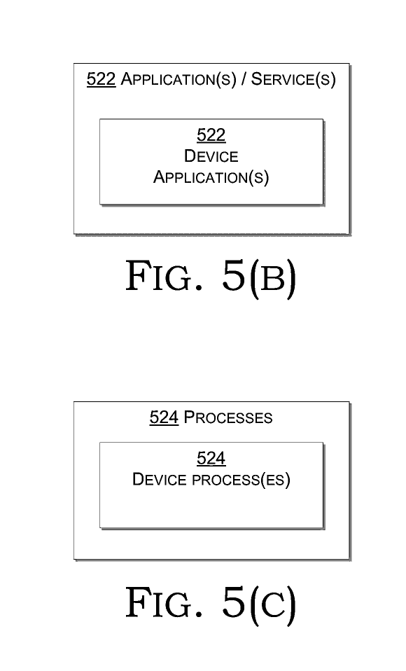

FIG. 5(A) is a schematic diagram of a computer system 500 upon which embodiments of the present disclosure may be implemented and carried out.

According to the present example, the computer system 500 includes a bus 502 (i.e., interconnect), one or more processors 504, one or more communications ports 514, a main memory 506, optional removable storage media 510, read-only memory 508, and a mass storage 512. Communication port(s) 514 may be connected to one or more networks (e.g., computer networks, cellular networks, etc.) by way of which the computer system 500 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 504 can be (or include) any known processor, such as, but not limited to, an Intel® Itanium® or Itanium 2® processor(s), AMD® Opteron® or Athlon MP® processor(s), or Motorola® lines of processors, and the like. Communications port(s) 514 can be any of an RS-232 port for use with a modem based dial-up connection, a 10/100 Ethernet port, a Gigabit port using copper or fiber, or a USB port, and the like. Communications port(s) 514 may be chosen depending on a network such as a Local Area Network (LAN), a Wide Area Network (WAN), a Content Delivery Network (CDN), or any network to which the computer system 500 connects. The computer system 500 may be in communication with peripheral devices (e.g., display screen 516, input device(s) 518) via Input/Output (I/O) port 520. Some or all of the peripheral devices may be integrated into the computer system 500, and the input device(s) 518 may be integrated into the display screen 516 (e.g., in the case of a touch screen).

Main memory 506 can be Random Access Memory (RAM), or any other dynamic storage device(s) commonly known in the art. Read-only memory 508 can be any static storage device(s) such as Programmable Read-Only Memory (PROM) chips for storing static information such as instructions for processor(s) 504. Mass storage 512 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 502 communicatively couples processor(s) 504 with the other memory, storage and communications blocks. Bus 502 can be a PCI/PCI-X, SCSI, a Universal Serial Bus (USB) based system bus (or other) depending on the storage devices used, and the like. Removable storage media 510 can be any kind of external hard-drives, floppy drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 506 is encoded with application(s) 522 that support(s) the functionality as discussed herein (an application 522 may be an application that provides some or all of the functionality of one or more of the mechanisms described herein). Application(s) 522 (and/or other resources as described herein) can be embodied as software code such as data and/or logic instructions (e.g., code stored in the memory or on another computer readable medium such as a disk) that supports processing functionality according to different embodiments described herein.

For example, as shown in FIGS. 5(B) and 5(C), respectively, application(s) 522 may include device application(s) 522 in FIG. 5(B) (corresponding to device/client application(s) 222 in FIG. 2(D)). As shown, e.g., in FIG. 2(D), device/client application(s) 222 (522 in FIG. 5(B)) may include system/administrative applications 234, user interface (UI) applications 236, storage applications 238, messaging and signaling applications 240, and other miscellaneous applications 242.

During operation of one embodiment, processor(s) 504 accesses main memory 506, e.g., via the use of bus 502 in order to launch, run, execute, interpret or otherwise perform the logic instructions of the application(s) 522. Execution of application(s) 522 produces processing functionality of the service(s) or mechanism(s) related to the application(s). In other words, the process(es) 524 represents one or more portions of the application(s) 522 performing within or upon the processor(s) 504 in the computer system 500.

For example, as shown in FIG. 5(C), process(es) 524 may include device process(es) 522, corresponding to one or more of the device application(s) 522.

It should be noted that, in addition to the process(es) 524 that carries(carry) out operations as discussed herein, other embodiments herein include the application 522 (i.e., the un-executed or non-performing logic instructions and/or data). The application 522 may be stored on a computer readable medium (e.g., a repository) such as a disk or in an optical medium. According to other embodiments, the application 522 can also be stored in a memory type system such as in firmware, read only memory (ROM), or, as in this example, as executable code within the main memory 506 (e.g., within Random Access Memory or RAM). For example, application 522 may also be stored in removable storage media 510, read-only memory 508, and/or mass storage device 512.

Those skilled in the art will understand that the computer system 500 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

We claim:

1. A computer-implemented method, implemented by hardware in combination with software, the method operable on a device for use in a multimodal communication framework, wherein users engage in conversations with each other via the communication framework, the method comprising:
(A) providing a graphical user interface (GUI) on said device, said GUI being implemented by said hardware in combination with said software;
(B) said GUI presenting a first portion of a conversation in a first conversation view on a display of said device, said first conversation view comprising (i) a first conversation region; and (ii) an input region distinct from said first conversation region, said first conversation region covering a first conversation area on said display of said device and said input region covering an input region area on said display of said device;
(C) in response to a first user interaction with said GUI, said first user interaction comprising interaction with the GUI to view a second portion of the conversation, said second portion of the conversation being distinct from the first portion of the conversation, said GUI
(C)(1) presenting said second portion of the conversation in a second conversation view on said display of said device, said second conversation view being distinct from said first conversation view, said second conversation view comprising a second conversation region covering a portion of said first conversation area and a portion of said input region area; and
(C)(2) deactivating at least said portion of said input region covered by said second conversation region.

2. The method of claim 1 wherein the first conversation view also comprises an information region, distinct from said input region and from said first conversation region, said information region covering an information region area on said display of said device, wherein, in (C), in response to said user interaction with said GUI, said GUI
(C)(3) causing at least some of said second conversation region to cover a portion of said information region area.

3. The method of claim 1 wherein, in said first conversation view, said input region includes a cursor displayed in or adjacent to said input region, and wherein, in said second conversation view, said cursor is displayed in a location outside of said second conversation region.

4. The method of claim 3 wherein said second conversation region has a rectangular shape and wherein, in said second conversation view, said cursor is displayed outside said rectangular shape.

5. The method of claim 4 wherein, in said second conversation view, said cursor is displayed on the left of said second conversation region.

6. The method of claim 1 wherein the first user interaction with the GUI in (C) comprises using the GUI to scroll within the conversation.

7. The method of claim 6 wherein the conversation comprises a time-ordered sequence of events, including a most recent event, and wherein said first portion of the conversation includes said most recent event, and wherein said GUI presents said second portion of said conversation using said second conversation view when said second portion of said conversation does not include said most recent event.

8. The method of claim 1, wherein the input region is positioned at a bottom portion of the conversation view and wherein the first conversation region is positioned above the input region.

9. The method of claim 1 further comprising:
(D) in response to a second user interaction with said GUI, said second user interaction occurring after said first user interaction and comprising interaction with the GUI to view said first portion of said conversation, said GUI:
(D)(1) presenting said first portion of the conversation using said first conversation view on said display of said device; and
(D)(2) activating said input region.

10. The method of claim 9 wherein, in said first conversation view, said input region includes a cursor displayed in or adjacent to said input region.

11. The method of claim 1 wherein the second user interaction with the GUI in (D) comprises using the GUI to scroll within the conversation.

12. The method of claim 11 wherein the conversation comprises a time-ordered sequence of events, including a most recent event, and wherein the second user interaction comprises using the GUI to scroll to the most recent event in the conversation.

13. The method of claim 1 wherein said first conversation region has a rectangular shape, having a first height, and wherein the second conversation region has rectangular shape having a second height greater than said first height.

14. The method of claim 13 wherein the second height is substantially the height of the display of the device.

15. The method of claim 6 further comprising:
said GUI displaying a time indicator over a portion of said conversation region.

16. The method of claim 15 wherein said time indicator is displayed over said portion of said conversation region while said user is using said GUI to scroll within the conversation.

17. The method of claim 16 wherein said time indicator is removed after said scrolling stops.

18. The method of claim 17 wherein said GUI determines that said scrolling has stopped when said user has not changed said conversation view for at least a predetermined period of time.

19. The method of claim 18 wherein said predetermined period of time is between 1 and 2 seconds.

20. The method of claim 15 wherein said time indicator comprises one or more of: (i) an iconic time indicator; and (ii) a textual time indicator.

21. The method of claim 20 wherein the time indicator provides an indication of time relative to a current time.

22. The method of claim 15 wherein, when scrolling, said UI renders at least some portions of the second conversation region at a lower intensity that other portions of the second conversation region.

23. The method of claim 22 wherein the at least some portions of the second conversation region that are rendered at a lower intensity comprise conversation elements at the top of the second conversation region.

24. The method of claim 22 wherein the at least some portions of the second conversation region that are rendered at a lower intensity comprise conversation elements in and above an area that includes the time indicator.

25. The method of claim 15 wherein, the conversation region comprises a background image, and wherein, when scrolling, said UI blurs at least a portion of said background image.

26. The method of claim 25 wherein the portion of the background image blurs continuously.

27. A device comprising hardware, including a processor and a memory, the device being programmed to perform a method comprising:
(A) providing a graphical user interface (GUI) on said device, said GUI being implemented by said hardware in combination with said software;
(B) said GUI presenting a first portion of a conversation in a first conversation view on a display of said device, said first conversation view comprising (i) a first conversation region; and (ii) an input region distinct from said first conversation region, said first conversation region covering a first conversation area on said display of said device and said input region covering an input region area on said display of said device;
(C) in response to a first user interaction with said GUI, said first user interaction comprising interaction with the GUI to view a second portion of the conversation, said second portion of the conversation being distinct from the first portion of the conversation, said GUI
(C)(1) presenting said second portion of the conversation in a second conversation view on said display of said device, said second conversation view being distinct from said first conversation view, said second conversation view comprising a second conversation region covering a portion of said first conversation area and a portion of said input region area; and
(C)(2) deactivating at least said portion of said input region covered by said second conversation region.

28. A tangible non-transitory computer-readable storage medium comprising instructions for execution on a device, wherein the instructions, when executed, perform acts of a method for supporting a graphical user interface (GUI) on said device, wherein the method comprises:
(A) providing a graphical user interface (GUI) on said device, said GUI being implemented by said hardware in combination with said software;
(B) said GUI presenting a first portion of a conversation in a first conversation view on a display of said device, said first conversation view comprising (i) a first conversation region; and (ii) an input region distinct from said first conversation region, said first conversation region covering a first conversation area on said display of said device and said input region covering an input region area on said display of said device;
(C) in response to a first user interaction with said GUI, said first user interaction comprising interaction with the GUI to view a second portion of the conversation, said second portion of the conversation being distinct from the first portion of the conversation, said GUI
(C)(1) presenting said second portion of the conversation in a second conversation view on said display of said device, said second conversation view being distinct from said first conversation view, said second conversation view comprising a second conversation region covering a portion of said first conversation area and a portion of said input region area; and
(C)(2) deactivating at least said portion of said input region covered by said second conversation region.
